(19) United States
(12) Patent Application Publication
(10) Pub. No.: US 2005/0247756 A1
(43) Pub. Date: Nov. 10, 2005

(54) Connection mechanism and method

(76) Inventors: James T. Frazer, Big Lake, MN (US); Terrance L. Morri, Shoreview, MN (US)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(21) Appl. No.: 11/094,331

(22) Filed: Mar. 30, 2005

Related U.S. Application Data
(60) Provisional application No. 60/557,945, filed on Mar. 31, 2004.

(51) Int. Cl. B23K 1/00

(52) U.S. Cl. 228/101

(57) ABSTRACT

A precision self-locking connection mechanism and method for connecting two parts or elements to one another and a precision self-locking connection mechanism and method in combination with a further connection mechanism for connecting two parts or elements together.

### BACKGROUND OF THE INVENTION

1. Field of the Invention

The present invention relates generally to a connection mechanism and method, and more specifically to a connection mechanism for connecting two parts or members to one another without the need for bolts, rivets, screws, clamps or other such external connecting means. In one embodiment of the invention, the connection mechanism utilizes a self-locking connection mechanism to connect elements to one another. In a further embodiment of the invention, a self-locking connection mechanism and method is used in combination with a further connection mechanism such as friction stir welding (FSW), brazing, bonding or other connection techniques to further enhance the connection force and to seal the connecting joint or seam.

2. Description of the Prior Art

A large number of what are commonly referred to as snap-in type or self-locking connection mechanisms are available in the art. Numerous examples exist of plastic or other material components having a wedge or arrow-shaped configuration with a protruding shoulder portion for insertion into a cavity or recess, or other opening having a complementary shoulder to retain the two elements together. For the most part, however, these are not precision connection mechanisms in which the mating interface surfaces are machined or manufactured to close tolerances so as to maximize the connection and retaining force between such elements. Thus, a need exists for improving the connection force of a self-locking connection mechanism.

Further, although various connection techniques or mechanisms are known in the art for joining two pieces of material together along a seam or joint, such as friction stir welding (FSW), conventional welding, brazing and bonding with epoxy or other adhesives, such techniques or mechanisms require the two pieces of material to be clamped or temporarily retained so that their respective seams or joints are in a relatively fixed position to one another during and sometimes after the application of the connection technique. After completion of such connection technique, and in some cases after a curing period as well, the clamping or other temporary retaining means is removed. The above connection techniques have several potential drawbacks: First, the clamps or other retaining means often interfere or are incompatible with application of the connection technique to a given seam or joint. For example, because of their particular configuration and/or location, some seams or joints cannot be easily clamped without elaborate and complex structure. Second, depending on the particular connection technique, clamps positioned on the seam or joint often need to be removed prior to applying the connection technique to that location. Third, when application of the connection technique is completed, the clamps or other temporary retaining means are removed, leaving the seam or joint secured only by such connection technique. Fourth, clamping fixtures are often cumbersome and complex and usually represent a large initial expense.

Accordingly, there is a need in the art for a connection mechanism and method embodying an improved self-locking mechanism, both individually and in combination with a further connection mechanism such as friction stir welding, conventional welding, brazing and bonding, among possible others.

### SUMMARY OF THE INVENTION

The present invention is directed to a connection mechanism and method for connecting two parts or members together with a precision, self-locking connection technique and the use of a self-locking connection technique in combination with a further connection technique such as friction stir welding, conventional welding, brazing and bonding to eliminate clamping or to otherwise retain the members during and/or after application of such further connection technique. This combination not only eliminates the need for clamping or otherwise retaining the elements in a fixed position during the application of such further connection technique, but because the self-locking connection mechanism remains after the further connection is completed, the strength of the resulting connection is significantly improved.

In general, the self-locking precision connection mechanism of the present invention is designed for connecting first and second parts or members to one another in a relatively permanent matter. In accordance with the present invention, each of the parts or members to be connected to one another includes a connection member with a mating connecting surface. One of such surfaces includes a connection rib or hook (both hereinafter referred to as a “rib”) extending outwardly from such surface while the other of such surfaces includes a corresponding connection groove or recess (both hereinafter referred to as a “groove”) to receive the connection rib in a connecting relationship. The self-locking connection mechanism of the present invention also includes a backing member or other means to assist in retaining the rib within the groove. Preferably either the connection rib or a surface adjacent to the connection groove is beveled to provide a lead in surface to enable one of the connection members to be locked into the connection groove. To improve the connection force of such connection mechanism, the connection members, including the connection rib, the connection groove and various related surfaces are provided with close preferably precision machined tolerances.

A further feature of the present invention is to utilize a self-locking connection mechanism such as the improved precision self-locking connection mechanism described above in combination with a further connection technique by providing a seam or joint between the two parts along which such further connection technique can be employed. Such a combination eliminates the need to use clamps or other external retaining means to maintain the two parts together during application of such other technique. Further, because the self-locking connection means is not removed after the application of such other connection technique, the combination results in a significantly greater connection force. Such other connection technique may include friction stir welding, conventional welding, brazing and bonding, among others.

Accordingly, it is an object of the present invention to provide an improved precision self-locking connection mechanism for connecting two members together.

A further object of the present invention is to provide a precision self-locking connection mechanism in which the two members to be connected have mating connection members with close tolerances to maximize the connecting strength.

A further object of the present invention is to provide a connection mechanism for connecting first and second members together which includes a self-locking connection method in combination with a further connection technique applied along a seam or joint formed by the self-locking connection.

A still further object of the present invention is to provide a method for connecting first and second members together with a precision self-locking connection mechanism.

Another object of the present invention is to provide a method for connecting first and second members together which includes connecting such members together utilizing a self-locking connection mechanism to form a connection seam or joint and applying a further connection technique to said seam or joint.

These and other objects of the present invention will become apparent with reference to the drawings, the description of the preferred embodiment and the appended claims.

### DESCRIPTION OF THE DRAWINGS

FIG. 1 is a fragmentary, isometric view, prior to connection, of first and second members embodying the precision self-locking connection mechanism in accordance with the present invention.

FIG. 2A is a fragmentary elevational front view of the connection mechanism shown in FIG. 1.

FIG. 2B is a view similar to that of FIG. 2A, but with the first and second members connected to one another.

FIG. 3 is an isometric view showing application of a friction stir welding connection technique to a butt joint seam between two members.

FIG. 4 is an elevational side view showing application of a friction stir welding connection technique to a lap joint between two members.

FIG. 5 is a sectional view of a further embodiment of a connection mechanism in accordance with the present invention showing a self-locking connection in combination with a brazing connection technique.

FIGS. 6, 7, 8, 9, 10, 11 and 12 are sectional views cut through a self-locking connection mechanism in accordance with the present invention showing a variety of configurations of the mating connection members and possible sites for friction stir welding.

FIG. 13 is an isometric view of a device showing first and second members prior to being connected together utilizing the self-locking connection mechanism in accordance with the present invention.

FIG. 14 is an isometric view of the device of FIG. 13 with the first member connected with the second member.

FIG. 15 is a view, partially in section, as viewed along the section line 15-15 of FIG. 14.

FIG. 16 is an enlarged sectional view showing the details of the connection at the outer ends of the device shown in FIG. 15.

FIG. 17 is an enlarged sectional view showing the details of the connection at the center of the device shown in FIG. 15.

FIGS. 18, 19 and 20 show sectional views of various further embodiments of self-locking connection mechanisms in accordance with the present invention for connecting first and second elements together.

FIG. 21 is a fragmentary, side elevational view showing two members embodying a non-linear, self-locking connection mechanism prior to connection.

FIG. 22 is a fragmentary, side elevational view of the connection mechanism of FIG. 21 with the two members connected.

FIG. 23 is an enlarged, fragmentary view, partially in section, as shown along the section line 23-23 of FIG. 22.

FIG. 24 is a side elevational view, prior to connection, of a further combination connection mechanism embodying self-locking and friction stir welding connection techniques.

FIG. 25 is a view of the combination connection mechanism of FIG. 24 after connection.

FIG. 26 is an enlarged view of the connection portion of FIGS. 24 and 25.

FIG. 27 is a side elevational view, prior to connection, of a further combination connection mechanism embodying self-locking and friction stir welding connection techniques.

FIG. 28 is a view of the combination connection mechanism of FIG. 27 after connection.

FIG. 29 is an enlarged view of the connection portion of FIGS. 27 and 28.

FIG. 30 is an isometric view of an aircraft wing section prior to connection of the cover and base components.

FIG. 31 is an isometric view of the inside of the cover component of the wing section of FIG. 30.

FIG. 32 is a schematic view of a connection mechanism between the wing components of FIG. 30, before connection.

FIG. 33 is a view similar to FIG. 32, but with the wing components connected to one another.

FIG. 34 is a side view showing a further connection of the type provided between the wing components of the wing section of FIG. 30 along the leading and trailing edges.

FIGS. 35, 36, 37 and 38 show various embodiments of a connection mechanism combination of a self-locking connection technique and an epoxy or other bonding material connection technique.

### DESCRIPTION OF THE PREFERRED EMBODIMENT

The present invention relates generally to an improved self-locking connection mechanism, by itself and in combination with a further connection mechanism, to connect two structural parts or members together. The invention also relates to a method of connecting two structural parts or members together utilizing a self-locking connection mechanism by itself and in combination with a further connection mechanism such as friction stir welding, conventional welding, brazing, bonding or the like.

As used herein, the term “self-locking” connection mechanism refers to a connection mechanism in which the connection, retaining or locking forces between two members result solely or substantially from the structural configuration of the respective elements themselves and do not rely on any external connection, retaining or locking means. While various self-locking connection mechanisms are covered by and fall within the scope of the present invention, both with respect to the self-locking mechanism itself and its combination with a further connection mechanism, the preferred mechanism will be described below.

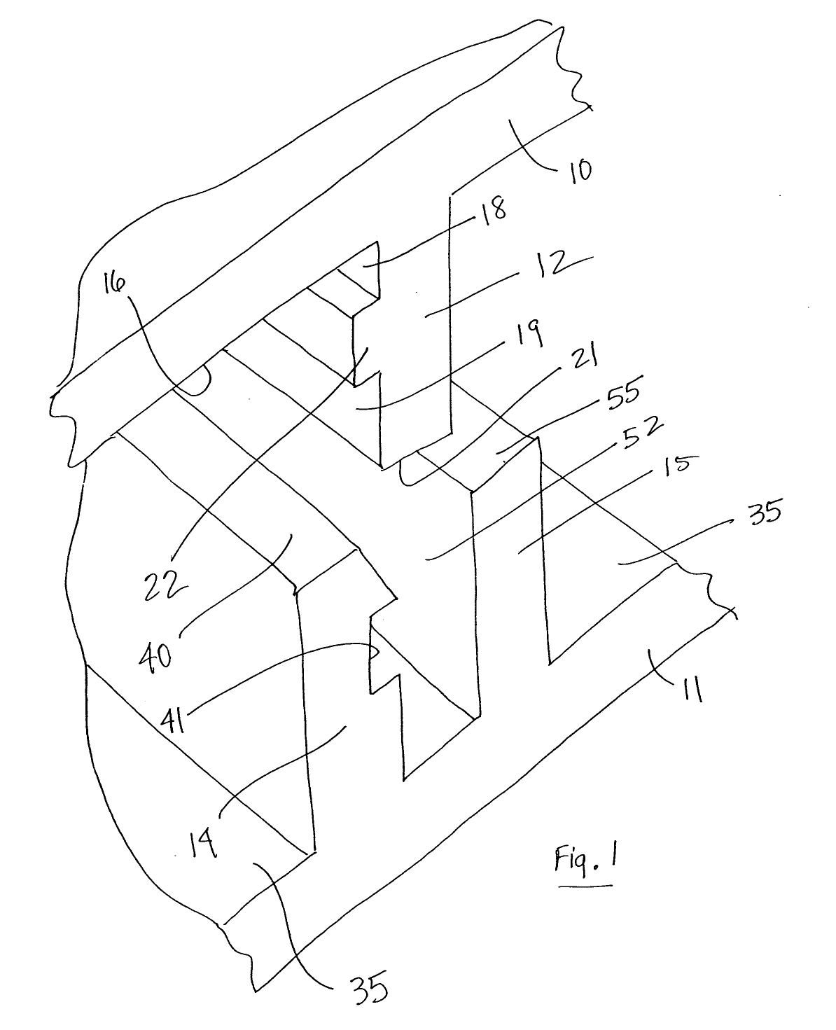

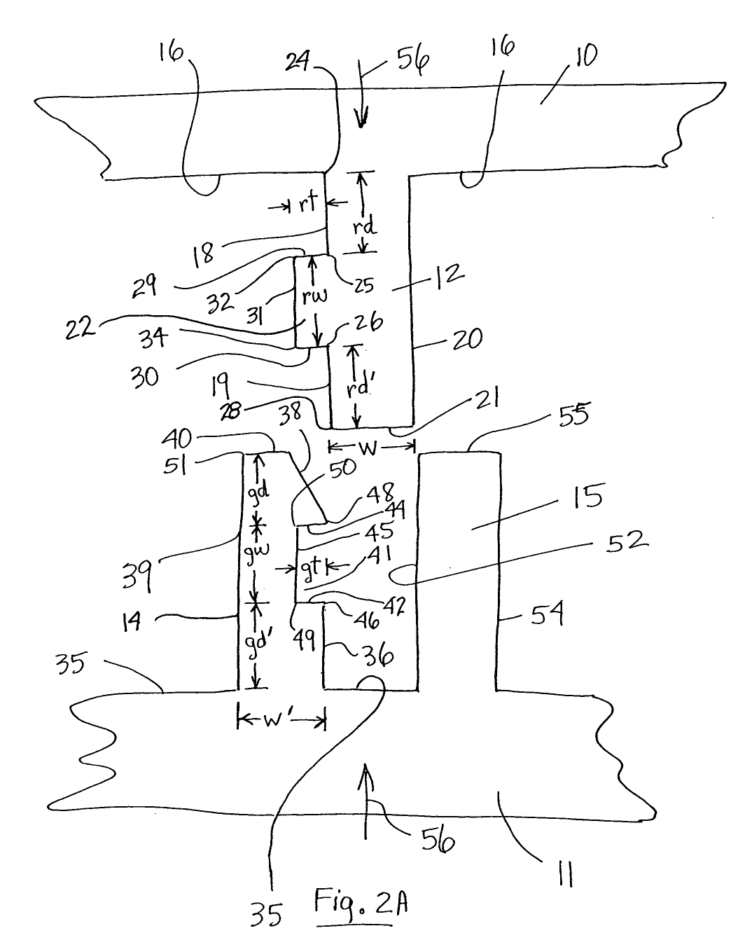

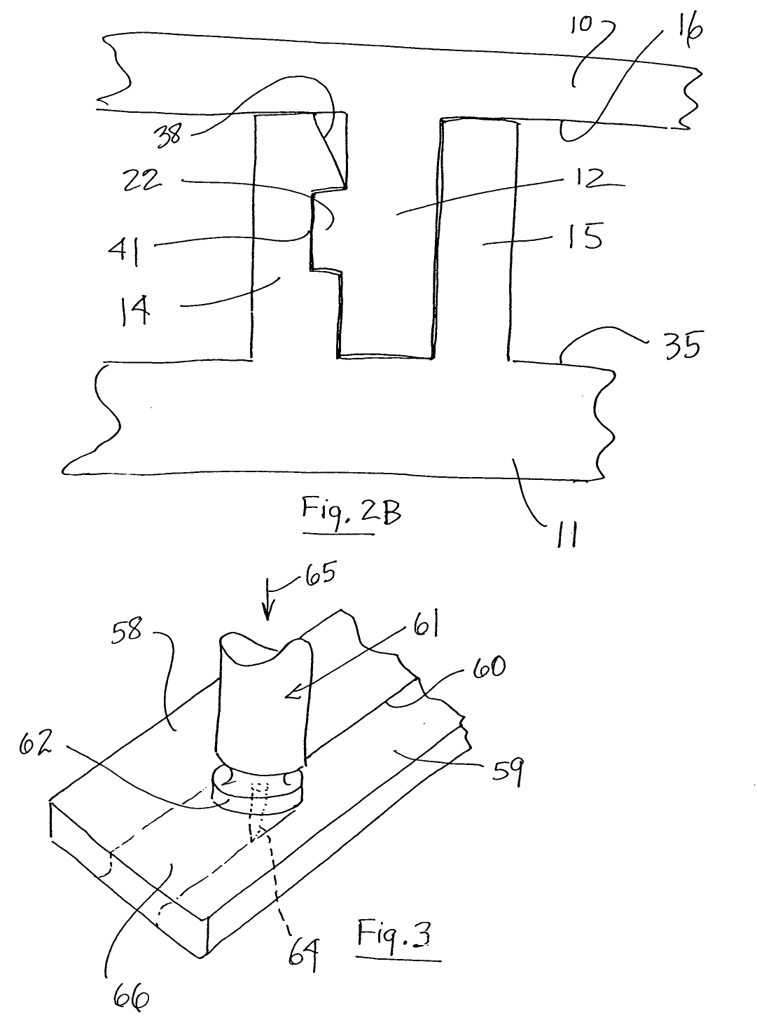

In describing the present invention, and more particularly, the detailed configuration of the preferred embodiment of the precision self-locking connection mechanism in accordance with the present invention, reference is first made to FIGS. 1, 2A and 2B. These figures show the detailed structural elements, surfaces, configurations and dimensional relationships for the self-locking connection mechanism of the present invention.

The connection mechanism in accordance with the present invention is designed for connecting a first part or member 10 to a second part or member 11 utilizing what will be referred to herein as a self-locking or a precision self-locking connection mechanism. The connection mechanism of the preferred embodiment as shown in FIGS. 1 and 2A/2B includes a first connection member 12 integrally formed with the first member 10, a mating or second connection member 14 integrally formed with the second member 11 and a backing member 15 spaced from the second connection member 14. The backing member 15 functions primarily to maintain the first and second connection members 12 and 14 in proper connection relationship. As shown and described below, the backing member 15 may function solely as a backing member as shown in FIGS. 1 and 2A/2B or may also function as a backing member and as a further connection member as shown in some of the other figures.

Throughout the application, the terms “proximal” and “distal” will be used in defining various components, surfaces, shoulders, etc. of the members 10 and I 1. Unless otherwise indicated, “proximal” shall mean the component, surface, shoulder, etc. closest to its corresponding member 10 or 11, while “distal” shall mean the component, surface, shoulder, etc. furthest from its corresponding member 10 or 11.

Also, unless otherwise indicated, the term “rib” with respect to a connection member shall include a rib of a connection member as shown (for example) by the reference character 22 in FIGS. 1 and 2A/2B as well as a hook portion of a connection member as shown (for example) by the reference character 146 of FIG. 36.

Unless otherwise indicated, the term “groove” or “recess” with respect to a connection member shall be synonymous and include a groove of a connection member as shown (for example) by the reference character 41 of FIGS. 1 and 2A/2B as well as the groove or recess as shown (for example) by the reference characters 143 and 147 of FIG. 36.

The first member 10 includes a base or main portion which is defined in part by a proximal surface 16. The proximal surface 16 is the surface of the first member 10 from which the first connection member 12 extends. As shown, the first connection member 12 extends outwardly from the proximal surface 16 and includes a first or connection side surface formed of the surface portions 18 and 19, an opposite second side surface 20 and a distal end surface 21. A connection rib 22 extends outwardly from the connection surface of the connection member 12 between the surface portions 18 and 19.

As shown, the surface portion 18 joins with the proximal surface 16 along a proximal edge 24. Although the surface portion 18 may extend outwardly from the proximal surface 16 at various angles, the preferred embodiment shows the surface portion 18 extending outwardly from the proximal surface 16 at right angles. The distal edge of the surface portion 18 joins with a proximal base shoulder 25 of the connection rib 22, while the proximal edge of the surface portion 19 joins with a distal base shoulder 26 of the connection rib 22. The distal edge of the surface portion 19 joins with the distal surface 21 of the connection member 12 along the edge 28. Although separated by the connection rib 22, the surface portions 18 and 19 are preferably coplanar with one another and thus, both surface portions 18 and 19 are preferably disposed at right angles relative to the proximal surface 16.

The rib 22 extends outwardly from the first connection member 12 along the shoulders 25 and 26 which define the distal and proximal edges of the surface portions 18 and 19, respectively. The connection rib 22 includes a proximal surface 29 which extends outwardly from the surface portion 18 along the shoulder 25 at approximately right angles and a distal surface 30 which extends outwardly from the surface portion 19 along the shoulder 26 at substantially right angles. The proximal and distal surfaces 29 and 30 of the connection rib 22 join with an outer rib surface 31 at the proximal distal shoulders 32 and 34 of the rib 22, respectively. In the preferred embodiment, the surfaces 29 and 30 extend outwardly from their respective surface portions 18 and 19 an equal distance and are generally parallel to the proximal surface 16. Preferably, the outer rib surface 31 joins with the rib surfaces 29 and 30 at right angles and is generally perpendicular to the proximal surface 16.

The second or opposite surface 20 of the connection member 12 is, in the embodiment of FIGS. 1 and 2A/2B, parallel to the surface portions 18 and 19 and extends outwardly from the proximal surface 16 at right angles. The distal surface 21 of the connection member 12 is parallel to the proximal surface 16 and thus joins with the surface 20 and the surface portion 19 at approximately right angles.

In defining the dimensional relationship of the various surfaces and configurations of the first connection member, the dimension “rw” defines the width of the connection rib 22, the dimension “rt” defines the thickness of the connection rib 22, the dimension “rd” defines the distance between the proximal surface 16 and the shoulder 25 and the dimension “rd” ′defines the dimension between the shoulder 26 and the distal surface 21. The dimension “W” ′defines the thickness of the connection member 12 as measured between the surface portions 18 or 19 and the surface 20.

The second member 11 also includes a base or main portion defined in part by a proximal surface 35 and a second connection member 14 extending outwardly from the proximal surface 35. The second connection member 14 includes a first or connection surface defined by the surface portions 36 and 38, a second or opposite surface 39 and a distal surface 40. As shown, a connection groove 41 is formed within the connection surface between the surface portions 36 and 38. Specifically, the groove 41 includes a proximal groove surface 42 which joins with and extends inwardly from the surface portion 36 along the proximal groove shoulder 46. The groove 41 also includes a distal surface 44 which joins with and extends inwardly from the surface portion 38 along the distal groove shoulder 48. The groove 41 also includes an inner surface 45 joining with the groove surfaces 42 and 44 along the groove edges 49 and 50, respectively.

Although the surface portion 36 may extend outwardly from the proximal surface 35 at various angles, this angle is a right angle in the preferred embodiment. In contrast, the surface portion 38 is preferably beveled as shown to provide a lead in surface for the connection rib 22 as will be discussed in greater detail below. The extent of the bevel of the surface 38 is preferably sufficient so that it will be engaged by the distal shoulder 34 of the connection rib 22 when the first connection member 12 is moved into connecting engagement with the second connection member 14.

The inner surface of the groove 41 is preferably perpendicular to the proximal surface 35 and also perpendicular to the groove surfaces 42 and 44. Thus, the groove surfaces 42 and 44 are also preferably parallel to the proximal surface 35.

In the embodiment shown in FIGS. 1 and 2A/2B, the second or opposite surface 39 extends outwardly from the proximal surface 35 at right angles and is thus parallel to the surface portion 36. The distal edge of the surface 39 joins with the distal surface 40 of the second connection member 14 at the edge 51.

Various dimensions of the second connection member 14 define the preferred dimensional relationship relative to the first connection member 12. Specifically, the dimension “gw” defines the width of the groove 41 between the shoulders 49 and 50, the dimension “gt” defines the thickness of the groove between the shoulders 46 and 49 or between the shoulders 48 and 50, the dimension “gd” defines the distance between the shoulder 50 or surface 44 and the distal surface 40 and the dimension “gd” ′defines the distance between the proximal surface 35 and the shoulder 49 or surface 42. The dimension W′ defines the thickness of the connection member 14 between the surface portion 36 and the surface 39.

The backing member 15 in the embodiment of FIGS. 1 and 2 is shown as a generally rectangular rib-type structure extending outwardly at substantially right angles from the proximal surface 35 of the member 11. The backing member 15 includes a first surface 52 facing the surface portions 36 and 38 and a second or opposite surface 54. A distal surface 55 extends between and is joined with the surfaces 52 and 54 at their distal edges.

In accordance with the present invention, the backing member 15 functions to define and maintain the first connection member 12 and the second connection member 14 in proper connecting relationship so that the rib 22 will interlock with and be retained within the groove 41. As will be described below, this backing member 15 may take the form of a structure such as shown in FIGS. 1 and 2A/2B which functions solely as a backing member or in the form of a structure which functions not only as a backing member, but also as a further connection member as shown and described below in many of the other embodiments.

Having described the detailed structure and configuration of the first and second members 10 and 11 and their respective first and second connection members 12 and 15, the manner in which the connection mechanism functions may be understood and described as follows.

To connect the first connection member 12 to the second connection member 14 and thus the first member 10 to the second member 11, the members 10 and 11 are moved toward one another in the direction of the arrows 56 (FIG. 2A). During this movement, the distal end of the first connection member 12 will enter the area between the second connection member 14 and the backing member 15. As this movement continues, the surface 20 of the connection member 12 will begin to engage and slide along the surface 52 of the backing member 15. As the members 10 and 11 continue to move toward one another, the distal shoulder 34 of the rib 22 will engage the beveled lead in surface 38 of the connection member 14. Continued movement of the members 10 and 11 toward one another will cause the second connection member 14 to flex outwardly (toward the left as viewed in FIGS. 2A/2B) to allow the connection rib 22 to move past the shoulder 48. When the rib 22 completely passes the shoulder 48, the second connection member 14 will snap back into its original, unflexed position, with the connection rib 22 seated within and received by the connection groove 41. In this connected position, as shown in FIG. 2B, the distal surface 21 of the first connection member 12 will be substantially engaged with the proximal surface 35 of the member 11 and the distal surface 40 of the second connection member 14 will be substantially engaged with the proximal surface 16 of the member 10. Further, the rib 22 will be seated within the groove 41 so that the rib surfaces 29 and 30 are substantially engaged with the groove surfaces 44 and 42 and the rib surface 31 is substantially engaged with the groove surface 45.

Because of machining or manufacturing tolerances for the first and second connection members 12 and 14 and their respective components, the dimension of the rib width “rw” should be slightly smaller (no more than about 0.001-0.005 inches) than the groove width “gw”. Similarly, the dimension “gd” should be slightly shorter (no more than about 0.001-0.005 inches) than the dimension “rd” and the dimension “gd” ′should be slightly shorter than (no more than about 0.001-0.005 inches) than the dimension “rd”′. The thickness of the rib 22 defined by the dimension “rt” may be equal to, and is preferably equal to, or slightly greater than (no more than about 0.001 inches) than the thickness of the groove identified by the dimension “gt”.

To enable the first and second connection members 12 and 14 to lock into connecting engagement with one another, at least one or more of the first and second connection members 12 and 14 and the backing member 15 must be sufficiently flexible to allow the connection rib 22 to move past the shoulder 48 of the connection member 14 and thus permit the rib 22 to seat within the groove 41. In addition to being sufficiently flexible to allow the connection members 12 and 14 to move into connecting engagement as described above, the flexible member or members must also have the ability to return to its normal, unstressed position after the connection members 12 and 14 have been moved into connecting relationship with the rib 22 inserted within the groove 41. In accordance with the present invention, at least one or more of the connection members 12 and 14 and the backing member is provided with such flexibility. This flexibility is provided by constructing it of a material which will permit such flexing when a flexing force is applied and which will allow it to spring back or return to its normal, unstressed position when such flexing force is removed. Such flexibility may also be provided by making the width of the connection member 14 (dimension “W”′) sufficiently small relative to its overall height to accommodate the flexing without breaking or otherwise becoming distorted. In accordance with the preferred embodiment, materials such as aluminum alloys, certain plastics and alloys of steel, titanium and various other metals exhibit acceptable ability to flex and spring back for purposes of the present invention. In the embodiment of FIGS. 1 and 2A/2B, the width of the connection member 14 designated by the dimension “W” ′is preferably less than about 30% of the height of the connection member 14 as measured from the proximal surface 35 to the distal surface 40 and more preferably less than about 20%.

In the self-locking connection mechanism shown in FIGS. 1 and 2A/2B, the connection member 12 is considered as embodying the connection rib 22 and the connection member 14 as embodying the connection groove 41. However, these could be reversed. For example, the connection member 14 could be considered as embodying the connection rib in the form of the hook or rib portion formed by the distal surface 44 and distal shoulder 48 and the connection member 12 could be considered as embodying the connection groove in the form of the recessed area defined by the surfaces 29, 18 and 16 between the rib 22 and the member 10.

A further feature of the present invention relates to a connection mechanism comprising a self-locking connection mechanism or a precision self-locking connection mechanism as described above in combination with a further connection technique such as friction stir welding, conventional welding, brazing and bonding, among others. As used herein, the term bonding shall mean any connection via glue, epoxies, adhesives, cements and the like. Specific examples of this combination will be described with respect to friction stir welding, brazing and epoxy.

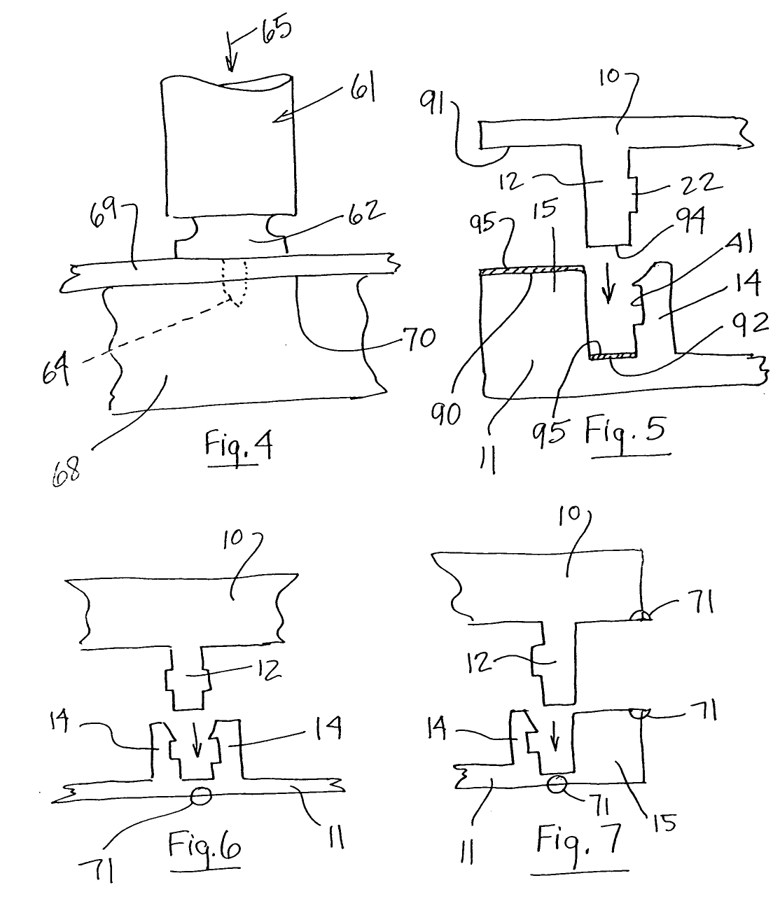

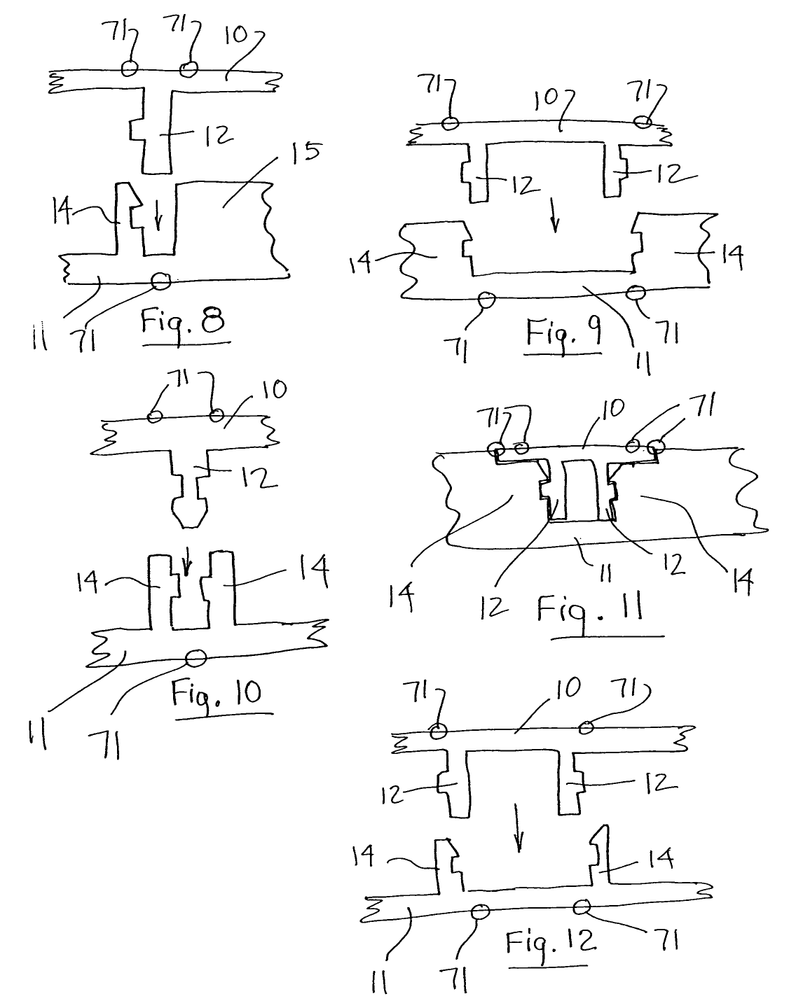

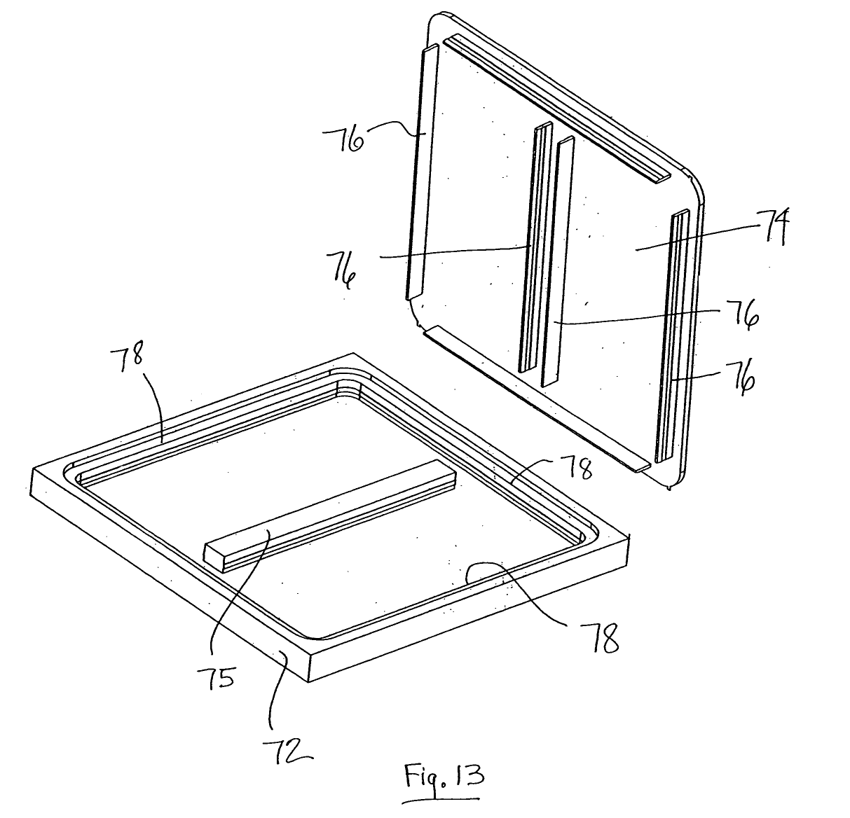

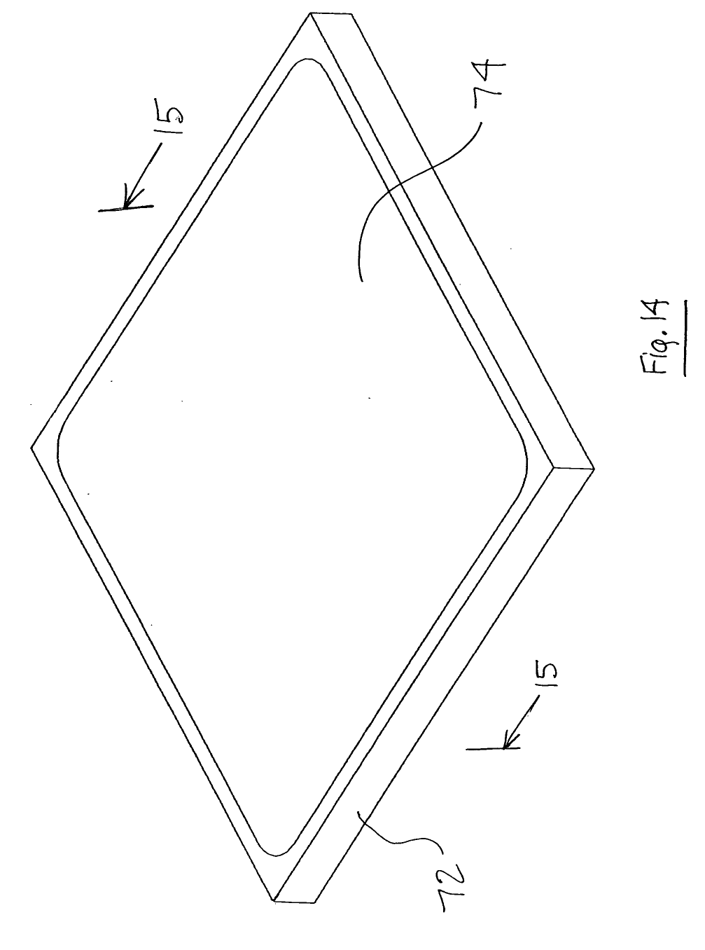

FIGS. 3 and 4 illustrate the concept of joining two parts or members together via friction stir welding. In FIG. 3, two pieces of material 58 and 59 are joined together along a butt seam or joint 60 by a friction stir welding tool 61. The tool 61 comprises, among other things, a rotating head 62 and a probe 64. During operation, the tool head 62 is rotated at high speed and a downward force 65 is maintained on the tool to maintain registered contact between the bottom of the head 62 and the top surface of the members 58 and 59. Because of the high rotational speed of the tool head 62 and the probe 64 against the parts 58 and 59, heat is generated. This heat is sufficient to cause the materials to soften without reaching a melting point and allows the probe 64 to traverse along the seam 60. As the tool moves along the seam 60, the material in front of the probe 64 is plasticized by the frictional heat and displaced to the back of the probe. At that point, the material cools to form a solid state, full penetration web 66. Friction stir welding connects parts together with a strength of up to 80% or more of the base metal.

FIG. 4 shows utilization of friction stir welding to join two parts 68 and 69 along a lap seam or joint 70. In this application, one of the parts 69 must be thin enough relative to the length of the probe 64 so that the probe can pass through the part 69 and plasticize a portion of the part 68 during the bonding process. In general, depending on the material, the member should have a thickness no greater than 1.25 inches and preferably a thickness less than that. The types of material that can be friction stir welded include aluminum alloys and alloys of magnesium, copper, steels, titanium and nickel.

Accordingly, friction stir welding requires the two members to be constructed of a material that can be friction stir welded as well as a seam or joint between the two members along which the weld can be applied. As shown in FIGS. 3 and 4, these may include a butt seam or joint in which two pieces of material are positioned in edge-to-edge relationship as shown in FIG. 3 or it may be a lap seam or joint in which two pieces of material are positioned with their major surfaces engaging one another as shown in FIG. 4. In the application of FIG. 4, however, one of the materials to be connected must be sufficiently thin to allow the probe 64 to penetrate through such material and into a portion of the other.

Further information regarding friction stir welding may be obtained from U.S. Pat. Nos. 5,460,317 and 5,813,592, the substance of which is incorporated herein by reference.

During a conventional friction stir welding process, it is essential that the two parts to be connected are held in a close (or engaged) and fixed relationship to one another. This is commonly accomplished using various types of clamps or other temporary retaining mechanisms. In doing this, problems may be encountered in the positioning of the clamps or other retaining means so as to maintain the seams or joints in this engaged, fixed relationship, without interfering with the travel path of the stir welding tool. After the weld is completed, the clamps or other retaining mechanisms are removed, leaving the stir friction weld as the only connection mechanism for the parts.

In accordance with a further feature of the present invention, a self-locking connection mechanism such as described above is used to form a friction stir welding seam or joint between two parts to be connected and to hold the two parts together in an engaged and fixed relationship so that they can be friction stir welded along such seam or joint. This provides a distinct advantage over prior art processes which utilize clamping or other temporary retaining means in that the present invention is able to provide a connection or retaining force free of clamps or other external means, in the immediate area of the seam or joint without interfering with the movement of the friction stir welding tool. Further, because the precision self-locking connection does not need to be removed after the friction stir welding process is completed, the self-locking connection mechanism functions to increase the overall holding strength of the connection. With the combination of the precision self-locking connection mechanism and friction stir welding, as described above, connection, retaining or locking forces between two connected members is increased.

While the combination of a precision self-locking connection mechanism in combination with friction stir welding is a preferred combination in accordance with the present invention, it is contemplated that other combinations of connection mechanisms may be utilized as well. For example, FIG. 5 shows the combination of a precision self-locking connection mechanism as described above in combination with a brazing connection mechanism. Specifically, brazing is a connection technique known in the art in which two parts are soldered together utilizing a non-ferrous alloy which melts at a temperature lower than the metals being connected. Accordingly, brazing requires the solder and such parts to be heated at least to the melting point of such alloy. The present invention contemplates utilizing a self-locking connection mechanism in combination with brazing for many of the same reasons as the combination of a self-locking connection with friction stir welding. Specifically, the self-locking connection eliminates the need for external clamping or other temporary retaining means to hold the parts during brazing and, when the brazing is completed, the self-locking connection remains and enhances the overall strength of the connection.

For a combination of a self-locking connection and brazing connection mechanisms, a self-locking connection preferably provides adjacent surfaces between the first member 10 and the second member 11 to provide a site for brazing. As shown in FIG. 5, the member 10 includes an outwardly extending first connection member 12 with a connection rib 22 on one of its side surfaces and the connection member 11 includes an outwardly extending connection member 14 containing a connection groove 41 for mating with the connection rib 22. The element 11 also includes a portion 15 which serves as a backing member. In the embodiment of FIG. 5, the elements 10 and 11 include at least two adjacent surfaces when connected. These include the surfaces 90 and 91 of the elements 11 and 10, respectively and the surfaces 92 and 94 of the elements 11 and 10, respectively. In accordance with the present invention, brazing material in the form of brazing foil 95 is applied to either of the surfaces 90 and 91 and/or either of the surfaces 92 and 94 prior to connection via the self-locking connection mechanism. Then, after the members 10 and 11 have been pressed together and joined via the self-locking connection, that portion of the members 10 and 11 in the area of the brazing foil 95 (between the surfaces 90 and 91 and between the surfaces 92 and 94) is heated to a temperature sufficient to melt the brazing foil and thus form a bond between the surfaces 90 and 91 and between the surfaces 92 and 94. As is known in the art, brazing temperatures can be as high as 1000° F. or more. Because of these high required temperatures, connection via friction stir welding is preferred over connection via brazing.

Having described the details of the precision self-locking connection mechanism of the present invention and the combination of such a connection mechanism with friction stir welding and with brazing, reference is next made to FIGS. 6-12 showing examples of various connection structures utilizing a self-locking connection mechanism as described above and identifying the seam or joint along which the friction stir welding technique may be employed. In these figures, reference characters similar to those used in FIGS. 1 and 2 will be used for purposes of identifying the main connection components. Specifically, reference characters 10 and 11 will refer to the first and second parts or members to be connected together, reference characters 12 and 14 will identify the first and second connection members of the parts 10 and 11, respectively and reference character 15 will identify the backing member. In these FIGS. 6-12, the location of the possible friction stir welding sites will be identified by the reference character 71.

In FIG. 6, the first member 10 includes an outwardly extending first connection member 12 with connecting ribs on each side, while the second member 11 includes a pair of outwardly extending second connection members 14, each including an inwardly facing groove to receive the connecting ribs of the connecting member 12. In the embodiment of FIG. 6, the pair of second connection members 14 also perform the function of a backing member. A possible site 71 for friction stir welding in the embodiment of FIG. 5 is through a portion of the member 11 and into the distal end of the connection member 12 as shown. This is a lap joint connection.

The embodiment of FIG. 7 is similar to that shown in FIGS. 1 and 2A/2B with the first member 10 including an outwardly extending first connection member 12 and the second member 11 including an outwardly extending second connection member 14 and a backing member 15. In the embodiment of FIG. 7, possible friction stir welding sites 71 may include a friction stir weld lap joint extending through the outer wall of the member 11 and into the distal end of the connection member 12 or may include a friction stir weld butt joint 71 along the lateral seam between the members 10 and 11.

FIG. 8 is also similar to the embodiments of FIGS. 1 and 2A/2B and FIG. 7 in that it shows the first member 10 with an outwardly extending connection member 12 and the second member 11 with an outwardly extending second connection member 14 and a backing member 15. This embodiment shows possible friction stir weld lap joint sites 71 extending through the thin wall of the member 10 and into the distal surface of the backing member 15, through the wall of the member 10 and into the distal surface of the connection member 14 or through the wall of the member 11 and into the distal end of the connection member 12.

The embodiment of FIG. 9 shows a first member 10 with a pair of outwardly extending first connection members 12 and a second member 11 with a pair of outwardly extending second connection members 14. As shown, the connection members 12 include outwardly extending ribs while the connection members 14 include corresponding inwardly facing grooves. In this embodiment, the second connection members 14 also function as the backing members. Possible friction stir welding sites 71 for this embodiment include friction stir weld lap joints which extend through the thin wall of the element 10 and into the distal surfaces of the connection members 14 or through the thin wall of the member 11 and into the distal ends of the connection members 12.

The embodiment of FIG. 10 includes a first element 10 with an outwardly extending first connection member 12 and a second member 11 with a pair of outwardly extending second connection members 14. In this embodiment, the first connection member 12 includes inwardly extending grooves on opposite sides, while each of the second connection members 14 includes an inwardly facing connection rib. In this embodiment, possible friction stir welding sites 71 may include lap joint sites in which the friction stir weld extends through the thin wall of the member 11 and into the distal end of the connection member 12 or through the thin wall of the member 10 and into the distal ends of either or both of the connection members 14.

The embodiment of FIG. 11 includes a first member 10 with a pair of outwardly extending first connection members 12 and a second member 11 with a pair of outstanding second connection members 14. In this embodiment, the pair of connection members 12 each include outwardly extending ribs, while each of the connection members 14 includes inwardly facing connection grooves. In this embodiment, the most distal portion of the element 11 includes a recessed area to receive the outer side edges of the element 10. This structure provides additional possible friction stir welding sites 71. Specifically, these possible sites 71 include friction stir weld butt joints along the seams between the outer side edges of the element 10 and the recessed areas within the element 11 as well as friction stir weld lap joints through the thin wall of the member 10 and into the distal surface of the recessed portion of the connection members 14.

The embodiment of FIG. 12 includes an element 10 with a pair of first connection members 12 and an element 11 with a pair of second connection members 14. As shown, the connection members 12 each include an outwardly extending connection rib while the second connection members 14 each include an inwardly facing connection groove. In this embodiment, the possible friction stir welding sites 71 include lap joint sites in which the weld extends through the thin wall of the element 11 and into the distal ends of either or both of the connection members 12 or through the thin wall of member 10 and into the distal end of either or both of the connection members 14.

Reference is next made to FIGS. 13-17 showing a device or product utilizing the self-locking connection mechanism in accordance with the present invention. The product shown in FIGS. 13-17 includes a base 72, a cover 74 and a self-locking connection mechanism in the form of the connection members 75, 76 and 78. FIG. 13 shows the base 72 and the cover 74 in a separated, unconnected position, while FIG. 14 shows the cover 74 connected to the base 72. Further reference will be made to FIGS. 15, 16 and 17 to describe the connection mechanism between the cover 74 and the base 72.

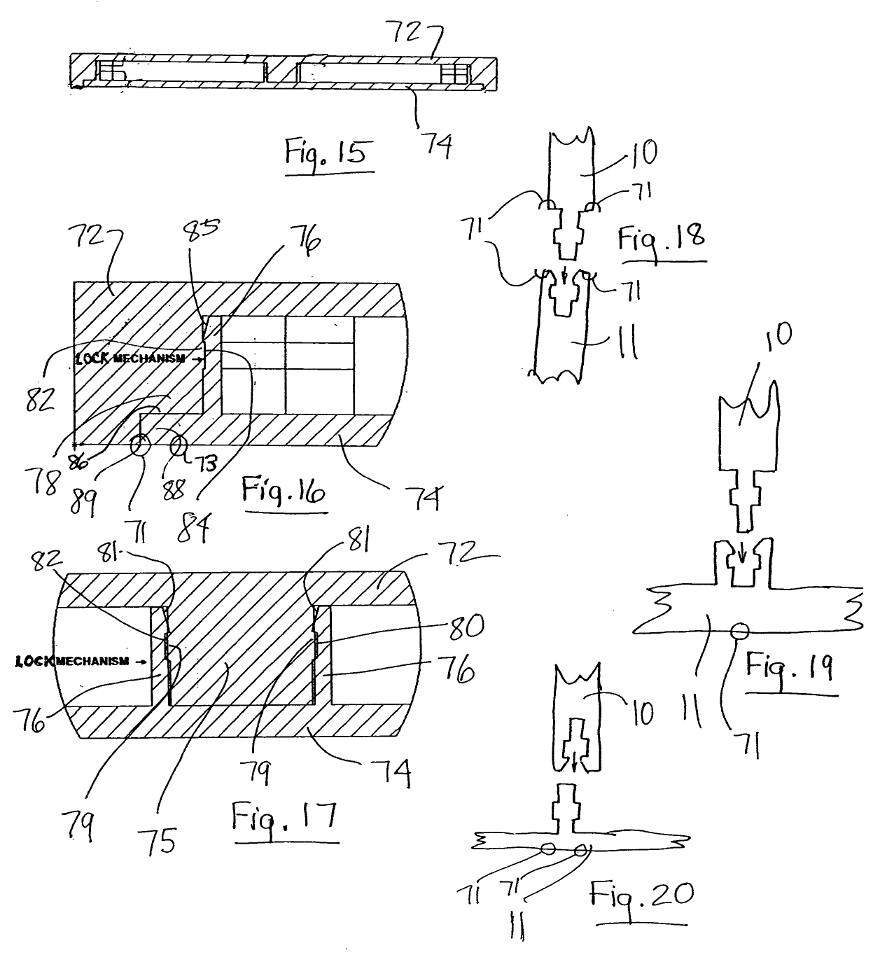

With reference to FIGS. 15 and 16, a connection mechanism is provided near the edges of the base 72 and the cover 74. Specifically, with reference to FIG. 16, a first connection member 78 is provided along each of the edges of the base 72. Each of these first connection members 78 includes an inwardly extending connection rib 82. A second connection member in the form of the outwardly extending connection fingers 76 is provided near each of the edges of the cover 74. As shown, each of these connection fingers 76 includes an inwardly formed connection groove 84 which is adapted to receive the connection rib 82 in connecting engagement. Each of the connection fingers 76 includes a beveled lead-in surface 85 between the groove 84 and the distal end of the finger 76. The fingers 76 are sufficiently flexible to allow the base 72 and cover 74 to be moved toward one another as the ribs 82 engage and flex their respective finger 76 and then lock within the groove 84 as shown in FIG. 17.

With reference to FIGS. 15 and 17, a similar connection mechanism is provided near the center of the base 72 and cover 72. Specifically, with reference to FIG. 17, the center portion of the base 72 includes an outwardly extending connection member 75 having a pair of connection ribs 79,79 on opposite side surfaces. The center portion of the cover 74 includes a pair of outwardly extending second connection members in the form of the connection fingers 76,76. As shown, these connection fingers 76,76 include inwardly facing connection grooves 80,80 which are configured and dimensioned to receive the connection ribs 79,79. The fingers 76,76 include a beveled, lead-in surface 81,81 between the grooves 80,80 and their respective distal ends. The fingers 76,76 are also sufficiently flexible so that when the connection member 75 is inserted between the connection fingers 76,76, the fingers will spread sufficiently to allow the connection ribs 79,79 to lock into the connection grooves 80,80.

In the particular embodiment of the device of FIGS. 13-17, a portion of the base along the edge of its open section includes a recessed portion 86 (FIG. 16) which is configured and dimensioned to receive a peripheral edge portion 88 of the cover 74. This provides a seam 89 between the base 72 and the cover 74 and thus a site 71 for a friction stir weld butt joint. A further site 73 for a friction stir weld lap joint is provided through the outer wall portion 74 and into a distal portion of the connection member 78.

FIGS. 18, 19 and 20 illustrate further embodiments utilizing the self-locking connection mechanism of the present invention to connect two parts or members together. Specifically, FIG. 18 shows connection in an edge-to-edge relationship with two possible sites 71 for friction stir weld butt joints and FIGS. 19 and 20 show connection in an edge-to-surface relationship with sites 71 for friction stir weld lap joints.

While the self-locking connection mechanisms described above are substantially linear in that the various connection members extend in substantially linear or straight lines, the present invention is equally applicable to self-locking connection members in which the first and second connection members do not extend linearly, but rather lie on a curve or in the form of a circle or other non-linear configurations. For example, FIGS. 21, 22 and 23 show a self-locking connection mechanism in which the locking mechanisms embody connection members which extend in a non-linear configuration. Specifically, the embodiment of FIGS. 21-23 includes a first member 90 embodying a pair of male connection members 91 and a second member 92 embodying a pair of female connection members 94. Each of the male connection members 91 includes a plurality of circumferentially spaced connection members or fingers 95 arranged in a circle. As shown best in FIG. 23, each of the fingers 95 extends outwardly from the member 90 and has an outwardly disposed hook or rib portion 96. Each of the female connection elements 94 comprises a substantially circular recess with a size and configuration substantially matching the circular configuration of the connection members 91. Each of the recesses 94 includes a circumferential groove 98 (FIG. 23) to receive the hook or rib portion 96 of the element 95.

To connect the members 90 and 92, the members are moved together in the direction of the arrow 93 so that the connection fingers 95 are inserted into the connection openings 94. During this insertion movement, the fingers 95 are flexed inwardly as they initially engage the outer edge of the respective openings 94. As the insertion continues, the outwardly facing hook or rib portions 96 snap into the recessed groove 98 to retain the fingers 95 within the connection openings 94 and to thereby provide a self-locking mechanism between the members 90 and 92. If desired, a further connection mechanism can be provided such as friction stir welding, bonding or others.

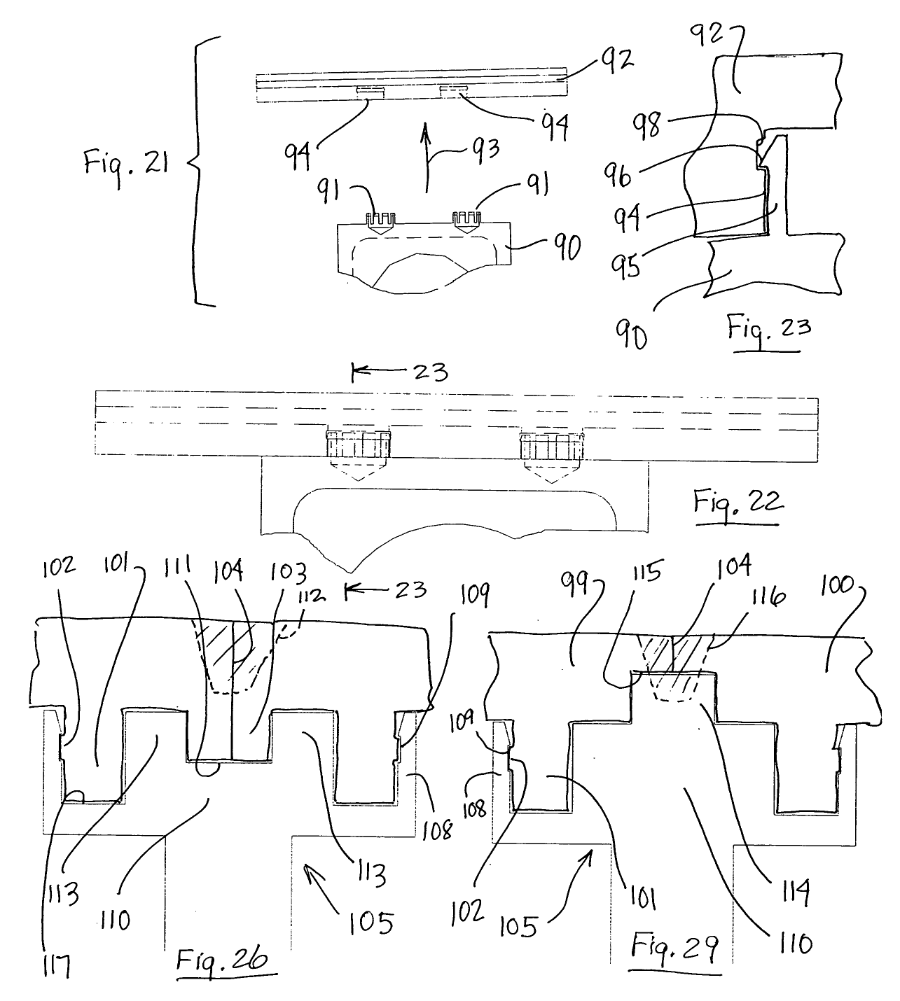

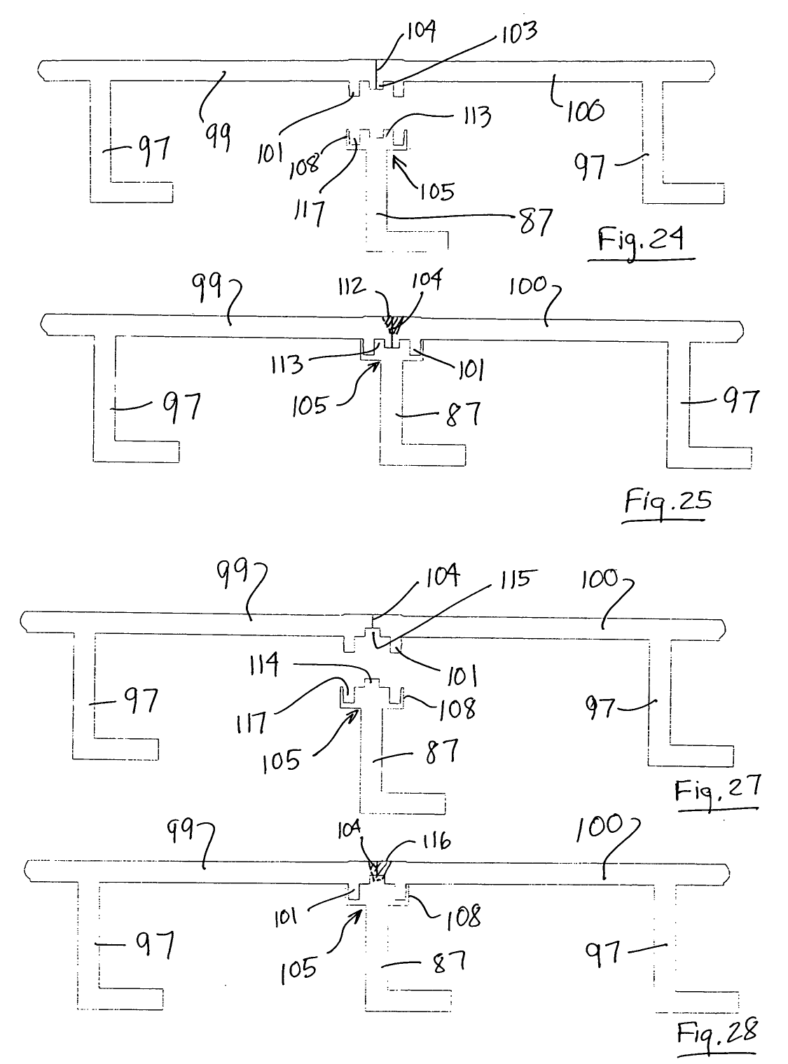

FIGS. 24, 25 and 26 show a further embodiment of a self-locking connection mechanism in combination with friction stir welding for joining two elements together through the use of a bridge or stringer member. Specifically, as shown, the two members 99 and 100 to be connected together each include an inner end mating surface designed for engagement with one another along the seam or joint 104 and a connection member 101 extending outwardly from an inner surface near its end mating surface. In the preferred embodiment, each of the members 99 and 100 also includes one or more stabilizing or support struts 97. Each of the connection members 101 includes a connection rib 102 formed on its outer side surface similar to the rib 22 of the embodiment shown in FIGS. 1 and 2A/2B. Each member 99,100 also includes a portion 103 adjacent to its respective end mating surface. This portion 103 and the inner side of the connection member 101 define a bridge receiving recess 107 between them.

A stringer or bridge member 105 shown best in FIG. 26 includes a pair of connection members 108 extending outwardly from a main body portion 110. Each of the members 105 includes an internal groove 109 to receive a rib 102 of a corresponding member 99 or 100. The stringer or bridge member 105 also includes a pair of outwardly extending portions 113 defining a center recess 111 between them and a side recess 117 between each portion 113 and a respective connection member 108. The bridge 105 may be a dedicated element whose sole function is to connect the members 99 and 100 or the bridge 105 may be a part of a structural member such as the strut 87 as shown in FIGS. 24-26.

When the members 99,100 and 105 are connected as shown in FIGS. 25 and 26, the connection members 101 are inserted into the recesses 117, the portions 103 are inserted into the recess 111 and the ribs 102 of the connection members 101 snap into the grooves 109 of the connection members 108. A further connection technique in the form of friction stir welding is then applied to the seam 104 as shown by reference numeral 112 in FIGS. 25 and 26. In this embodiment, the friction stir welding site 112 is a butt joint along the seam 104.

The embodiment of FIGS. 27, 28 and 29 is similar to that of FIGS. 24-26 except that the main body portion 110 of the bridge 105 includes a rib member 114 instead of the recess 111 and each of the members 99 and 100 include a recess instead of the portions 103. When assembled, as shown in FIGS. 28 and 29, the connection members 101 are inserted into the recesses 117, the ribs 102 snap into and area retained within the grooves 109 of the connection members 108 and the rib member 114 is inserted into the recess 115. A further connection technique in the form of friction stir welding 116 is then applied along the seam 104 and partially into the rib member 114 as shown. In this embodiment, the friction stir weld 116 is a combination butt joint and lap joint in that a portion joins inner ends of the members 99 and 100 along the seam 104 as a butt joint and a portion extends through portions of the members 99 and 100 adjacent to the seam 104 and into the top surface portion of the rib 114 as a lap joint.

The connection mechanism and method in accordance with the present invention has a wide range of applications for permanently connecting elements, members or parts to one another. However, it has particular application in the aircraft and automotive industry and any other industry which requires requiring connection of various components or members to one another and in which those components or members are constructed of materials suitable for friction stir welding such as aluminum, copper, lead and magnesium and alloys thereof. One example of an application of the present invention in the aircraft industry is in the construction of an aircraft wing as shown in FIGS. 30-34. Specifically, FIG. 30 shows a section of an aircraft wing comprised of a base section 118 and a cover section 119. Such components, using conventional connection techniques would be connected to one another using a plurality of aircraft rivets extending through the cover 119 and into struts or stringers of the base 118. In accordance with the present invention, however, such components can be connected to one another using a self-locking mechanism followed by a further connection technique such as friction stir welding.

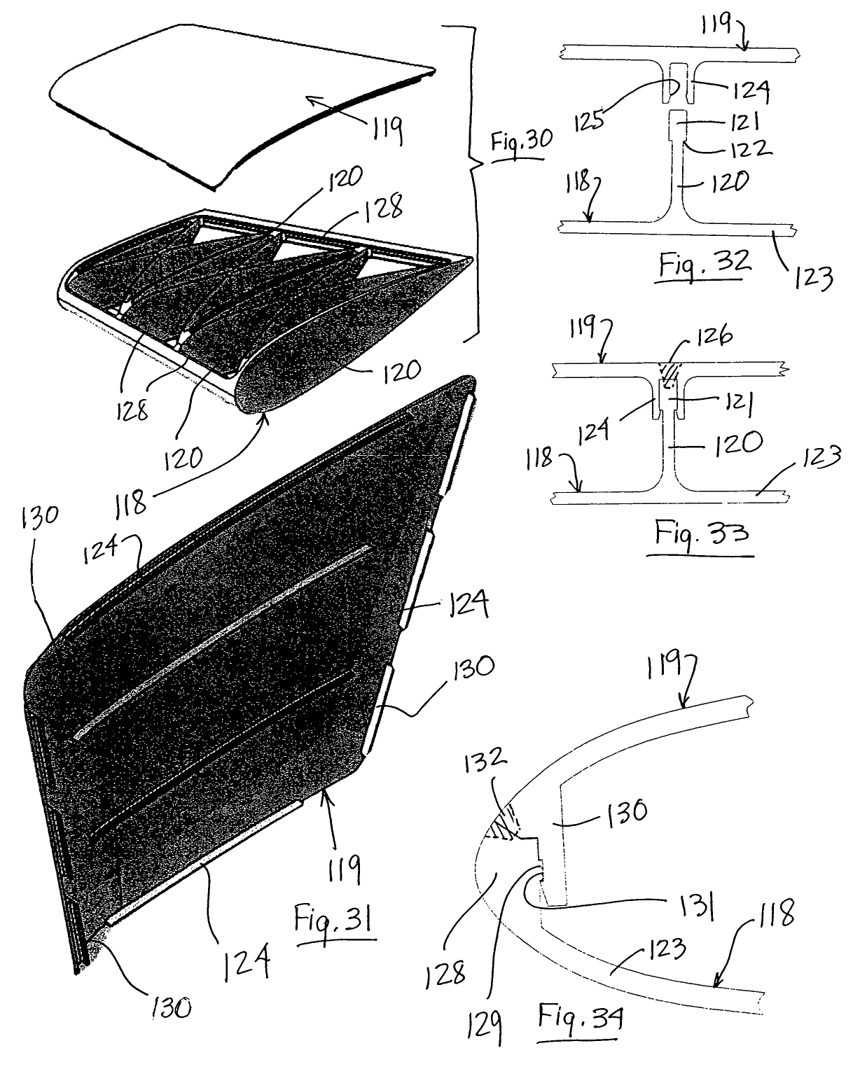

As shown in FIG. 30, the base 118 includes a plurality of beams or struts 120 which are laterally spaced from one another along the length of the wing. As shown schematically in FIG. 32, each of the struts 120 is integrally joined with a bottom panel 123 of the base 118 at its lower end and includes a male connection member 121 at its upper or outer end. The lower end of each of the connection members 121 is provided with a recessed notch 122 as shown.

The inner surface of the cover portion 119, as best shown in FIGS. 31 and 32, is provided with a plurality of corresponding second connection members in the form of a pair of spaced connection fingers 124,124. As shown best in FIG. 32, each of these connection fingers 124 includes a hook portion 125 as shown. When the cover 119 is connected with the base 118 as shown in FIG. 33, the hook portions 125 snap over and engage the recessed portions 122 of the connection member 121. Friction stir welding is then applied at the site 126 to connect the cover 119 to the base 118 via connection with the member 121. This is a lap joint in which the friction stir weld extends through the cover and into a portion of the member 121.

Each of the forward and rearward edges of the base 118 also include a plurality of connection members 128 as shown best in FIG. 34. Each of the members 128 further includes an outwardly extending rib portion 129. As shown in FIGS. 31 and 34, the inner surface of the cover 119 is also provided with a plurality of corresponding connection members 130 along their leading and trailing edges. The specific structure and configuration of these connection members is also shown best in FIG. 34. Each of the connection members 130 includes a recess 131 to accommodate and receive the rib 129 of the connection member 128 when the cover 119 and the base 118 are connected. When so connected, a further connection technique in the form of friction stir welding 132 is applied along the seam in the form of a butt joint between extended edges of the connection member 128 and the connection member 130 as shown.

Accordingly, the aircraft wing section of FIGS. 30-34 includes a base member having a first set or plurality of self-locking connection members and a cover member having a second set or plurality of cooperating or mating connection members. During assembly, the cover 119 is first connected to the base 118 by engaging the connection members 124 with their corresponding connection members 121 and by engaging the connection members 130 with their corresponding connection members 128. This is followed by friction stir welding through the cover and into the outer ends of the connection members 121 via the friction stir weld 126 and along the seam between the cover and the base via the friction stir weld 132.

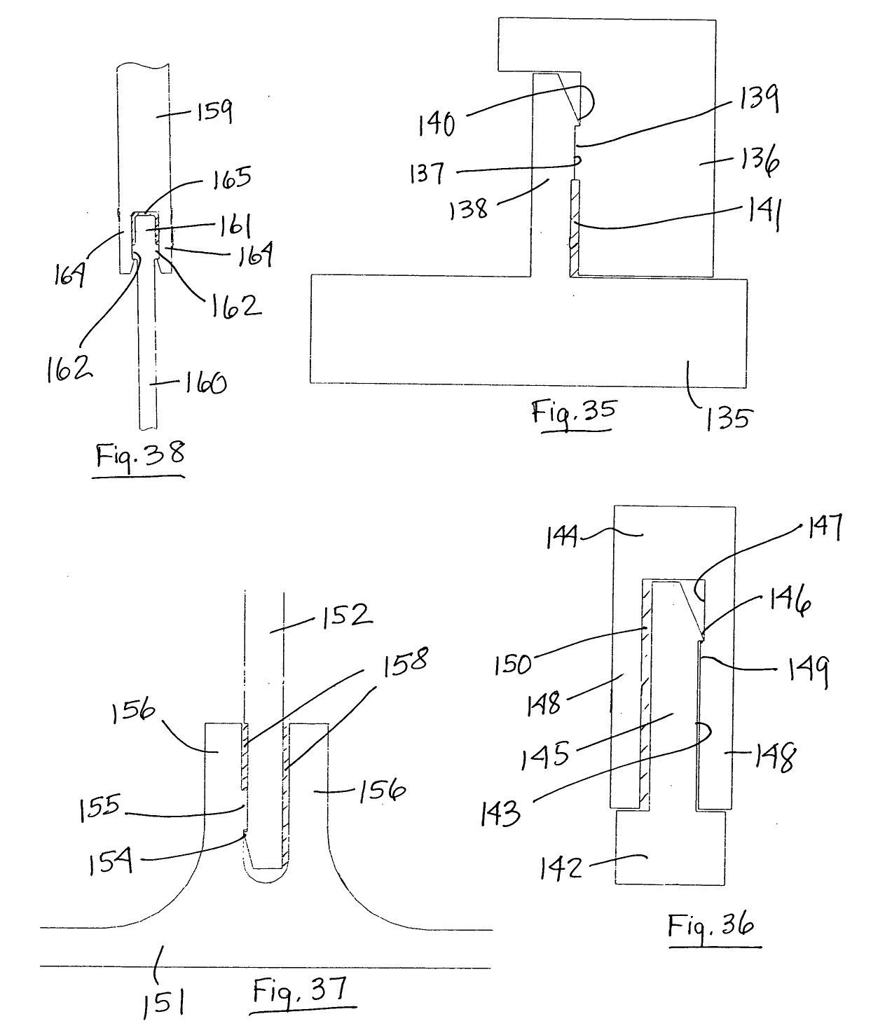

FIGS. 35-38 show various connection mechanisms embodying a combination of a self-locking connection mechanism with epoxy. FIG. 35 shows members 135 and 136 which are connected to one another utilizing this combined technique. As shown, the member 135 includes a first connection member 138 having a hook portion 140 near its outer end and a recess 137 below the hook 140. The member 136 includes a rib member 139 which seats within the recess 137 and is engaged by the hook portion 140 when the members 135 and 136 are assembled together. An epoxy or other bonding material gap 141 is provided between a portion of the connection member 138 and the member 136 as shown.

In FIG. 36, the members 142 and 144 are connected with one another. The member 142 includes a connection member 145 extending outwardly therefrom and a hook portion 146 near its outer end defining a recess 143. The member 144 includes a pair of finger-type connection members 148. One of the members 148 includes a rib member 149 for engagement with the hook portion 146 and seating within the recess 143. The member 148 can also be considered as embodying a recess or groove 147 for engagement by the hook or rib 146. An epoxy or other bonding material receiving gap 150 is provided between the side of the connection member 145 opposite the hook 146 and one of the connection fingers 148. In this embodiment, the bonding material in the gap 150 functions both to hold the members 142 and 144 together as well as to assist in retaining the hook 146 in engagement with the rib 149.

In FIG. 37, the members 151 and 152 are joined together. As shown, the outer end of the member 152 is provided with a hook portion 154 and the member 151 is provided with a pair of outstanding finger-type connection members 156. One of the connection members 156 is provided with a rib 155 for engagement by the hook portion 154 and for seating within the recess defined by the hook 154. In this embodiment, the connection members are configured to provide an epoxy or other bonding material gap 158 on both sides of the member 152 and between the connection members 156,156.

In FIG. 38, the member 160 is connected with the member 159. The member 160 includes a connection member 161 at its outer end and a pair of connection ribs 162 on opposite sides. The member 159 includes a pair of spaced connection members in the form of the connection fingers 164. Each of these fingers 164 includes a hook near its outer end for engagement with the ribs 162 as shown. The hooks define a recess within which the ribs 162 are seated. An epoxy or other bonding material receiving gap 165 is provided between the outer end and sides of the member 161 and the fingers 164 to assist in the connection between the members 160 and 159.

Although the description of the preferred embodiment has been quite specific, it is contemplated that various modifications could be made without deviating from the spirit of the present invention. Accordingly, it is intended that the scope of the present invention be dictated by the appended claims rather than by the description of the preferred embodiment.

1. A connection mechanism for connecting first and second parts to one another comprising:
a first part to be connected having a first connection member, said first connection member having a connection surface and a connection rib extending outwardly therefrom;
a second part to be connected having a second connection member, said second connection member having a connection surface generally parallel to the connection surface of said first connection member and a connection groove formed therein to receive said connection rib;
a backing member extending outwardly from the surface portion of one of the first and second members to retain the first and second connection members in connecting engagement with said connection rib received within said connection groove; and
at least one of said first and second connection members and said backing member being sufficiently flexible to permit said connection rib to be inserted into and received by said connection groove.

2. The connection mechanism of claim 1 in combination with a further connection mechanism.

3. The connection mechanism of claim 2 wherein said further connection mechanism is one or more of friction stir welding, brazing and bonding.

4. The connection mechanism of claim 2 wherein said further connection mechanism is friction stir welding.

5. The connection mechanism of claim 2 wherein said further connection mechanism is bonding.

6. A connection mechanism for connecting first and second parts together comprising the combination of:
a self-locking connection mechanism and
a further connection mechanism comprising one or more of friction stir welding, brazing, conventional welding and bonding.

7. The connection mechanism of claim 6 wherein said self-locking connection member includes a first connection member and a second connection member, one of said first and second connection members including a connection rib and the other of said first and second connection members including a connection groove to receive said connection rib.

8. The connection mechanism of claim 7 wherein said further connection mechanism is friction stir welding.

9. The connection mechanism of claim 8 wherein said one first and second connection members includes a connection rib on each side thereof and said other first and second connection members includes a connection groove on each side thereof.

10. The connection mechanism of claim 9 wherein said first connection member includes a connection rib on each side thereof and said second connection member includes a connection groove on each side thereof.

11. A method of connecting first and second parts together comprising:
providing a first part with a first self-locking connection member;
providing a second part with a second self-locking connection member, said first and second self-locking connection members being selectively connectable to one another via a self-locking connection;
connecting said first and second parts via said self-locking connection to provide a connection site; and
applying a further connection mechanism to said connection site.

12. The method of claim 11 wherein said further connection mechanism is one of friction stir welding, brazing, conventional welding and bonding.

13. The method of claim 12 wherein said further connection mechanism is friction stir welding.

14. The method of claim 11 wherein said connection site is a seam between first and second edges of said first and second members.

15. The method of claim 14 wherein said further connection mechanism is friction stir welding applied along said seam.

16. The method of claim 11 wherein said further connection mechanism is friction stir welding applied through a portion of one of said first and second members and into a portion of the other of said first and second members.

17. A method of connecting first and second parts together comprising:
providing a first member with a first self-locking connection member;
providing a second member with a second self-locking connection member;
providing a bridging member with first and second complementary self-locking connection members, said first and second complementary connection members being selectively connectable to said first and second connection members via a self-locking connection;
connecting said first and second pars together via said bridging member and said self-locking connection to provide a connection site between said first and second members; and
applying a further connection mechanism in the form of a friction welding to said connection site.

18. The method of claim 17 wherein said further connection mechanism is one or more of friction stir welding, brazing, conventional welding and bonding.

19. The method of claim 18 wherein said further connection mechanism is friction stir welding.

20. An aircraft wing comprising:
a base member having a plurality of spaced struts, each of said struts including an edge with a first connection member along said edge;
a cover member having a plurality of second connection members spaced along an inner surface thereof to correspond to the first connection members of said struts, said first and second connection members being selectively connectable to one another via a self-locking connection; and
said base member and said cover member connected to one another via said self-locking connection.

21. The method of claim 20 wherein said base member and said cover member are further connected to one another by a further connection mechanism comprising one or more of friction stir welding, brazing, conventional welding and bonding applied in the area of engagement between said first and second connection members.

22. The method of claim 21 wherein said further connection mechanism is friction stir welding.

23. A method of making an aircraft wing comprising:
providing a base with a plurality of struts, at least one of said struts including a first connection member along an edge thereof;
providing a cover with a second connection member corresponding to said first connection member, said first and second connection members being selectively connectable to one another via a self-locking connection;
connecting said base and cover via self-locking connection; and
applying a further connection mechanism between said cover and said base in the area of said self-locking connection by one or more of friction stir welding, brazing, conventional welding and bonding.
